(19) United States
(12) Patent Application Publication
(10) Pub. No.: US 2018/0034828 A1
(43) Pub. Date: Feb. 1, 2018

(54) POSITIVE DISCONNECT UNIT

(71) Applicant: CIS Secure Computing, Inc., Dulles, VA (US)

(72) Inventors: Frederick E. KOENIG, Nokesville, VA (US); Daniel GAVIN, Charles Town, WV (US)

(21) Appl. No.: 15/660,239

(22) Filed: Jul. 26, 2017

Related U.S. Application Data
(60) Provisional application No. 62/368,412, filed on Jul. 29, 2016.

(51) Int. Cl. H04L 29/06

(52) U.S. Cl. CPC H04L 63/145; H04L 63/1425

(57) ABSTRACT

A disconnect unit may include a first interface, configured to communicate with an accessory, a second interface, configured to communicate with a communication device, a relay, configured to physically connect and disconnect a communication path between the first interface and the second interface, and a codec unit, configured to maintain a software-level connection with the communication device via the second interface on behalf of the accessory.

### RELATED APPLICATIONS

This application claims the benefit of priority to U.S. Provisional Application No. 62/368,412 entitled “Positive Disconnect Unit” filed Jul. 29, 2016, the entire contents of which is hereby incorporated by reference.

Communication security is a vital part of many aspects of government and business. While encryption and other means of signal obfuscation may provide a layer of security for communication devices in operation, proper communication security must also consider preventing or mitigating unintentional signal transmissions. For example, software controlling a communication session (e.g., a “soft phone”, an internet communication session such as Skype, etc.) may include a “mute” feature that purports to prevent transmission of sounds and/or images during a phone call or other communication session. However, even when such a mute feature is activated, an accessory (e.g., a microphone, a telephone handset, a camera, etc.) may still operate receive inputs, generate output signals based on the received inputs, and send the output signals to a communication device. This is because the mute feature typically only functions at a software level to block the output signals (received from an accessory) from being transmitted by the communication device. However, because the communication device still receives the output signals from the accessory, it is possible for the communication device to be compromised by an attacker (e.g., via a software and/or hardware exploit), who may then eavesdrop on the output generated from the accessory.

### SUMMARY

Various embodiments include systems and methods of positively disconnecting electronic signal paths from an accessory device (e.g., an input device) to block transmission of a signal from the input device to a communication device. In some embodiments, a disconnect unit may electromechanically break an electronic signal path, such as an audio path or a USB path, between the accessory and the communication device. In some embodiments, the disconnect unit may maintain communication with the communication device on behalf of the accessory so that signal paths between the accessory and the communication device may be opened (to disconnect the signal paths between the accessory and the communication device) and closed (to reestablish the signal path), and input from the accessory may be provided to the communication device (e.g., to continue a communication session) without a delay that may be caused, for example, by reinitialization of a driver for the input device. In some embodiments, the disconnect unit may open and/or close the signal path while maintaining a communication session that uses input from the accessory.

Various embodiments may include a disconnect unit, including a first interface, configured to communicate with an accessory, a second interface, configured to communicate with a communication device, a relay, configured to physically connect a communication path between the first interface and the second interface, and a codec unit, configured to maintain a software-level connection with the communication device via the second interface on behalf of the accessory. In some embodiments, the relay may be configured to physically disconnect the communication path in a default operating state. In some embodiments, the relay may be configured to physically connect the communication path in a connected operating state. In some embodiments, the relay may include an electromechanical device configured to physically connect the communication path between the first interface and the second interface.

Some embodiments may further include a user interface, configured to receive an input, wherein the relay may be configured to physically connect the communication path in response to the input received at the user interface. In some embodiments, the codec unit may be configured to maintain the software-level connection with the communication device when the communication path is physically disconnected.

Some embodiments may further include a timer unit, configured to count a first time period during which the disconnect unit may operate with the communication path physically connected. In such embodiments, the timer unit may be configured to send a signal to the relay to physically disconnect the communication path in response to determining that the first time period has expired. In some embodiments, the timer unit may be configured to count a second time period after the first time period has expired, and may be configured to send a signal to the relay to physically disconnect the communication path in response to determining that the second time period has expired.

Various embodiments may include an electrical circuit, including a first interface, configured to communicate with an accessory, a second interface, configured to communicate with a communication device, a relay, configured to physically connect a communication path between the first interface and the second interface, and a codec unit, configured to maintain a software-level connection with the communication device via the second interface on behalf of the accessory. In some embodiments, the codec unit may be electrically coupled to the second interface. In some embodiments, the relay may be electrically coupled to the first interface. In some embodiments, when the communication path is physically connected by the relay, the relay may be electrically coupled to the codec unit. In some embodiments, the codec unit is may be configured to maintain the software-level connection with the communication device via the second interface on behalf of the accessory when the relay physically disconnects the communication path.

Various embodiments may include a method of performing operations of the embodiments summarized above. Various embodiments may include a non-transitory processor-readable storage medium having stored thereon processor-executable software instructions configured to cause a processor to perform operations of the embodiments summarized above. Various embodiments may include a disconnect unit and/or an electrical circuit that includes means for performing functions of the embodiments summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of various embodiments.

FIG. 1 is a block diagram of a communication system including a disconnect unit according to various embodiments.

FIGS. 2-4 are component diagrams illustrating an embodiment disconnect unit according to various embodiments.

FIG. 5 is a block diagram illustrating a system including a disconnect unit according to various embodiments.

FIGS. 6, 7A, and 7B are circuit diagrams illustrating components of an embodiment disconnect unit.

FIG. 8 is a process flow diagram illustrating a method for positively disconnected a signal path according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of various embodiments or the claims.

Conventional communication security solutions use encryption and signal obfuscation techniques to provide a layer of security for communication devices (e.g., laptop computing devices, smartphones, etc. etc.) and their accessories. However, conventional solutions do not adequately identify and prevent unintentional or surreptitious signal transmissions.

Software applications controlling a communication session (e.g., a “soft phone”, an internet communication session such as Skype, etc.) often include a “mute” feature. Activating the mute feature causes the software to electronically prevent transmission of sounds and/or images during communication session (e.g., phone call). Yet, the communication device's accessories (e.g., a microphone, camera, etc.) still capture inputs (e.g., sounds, etc.), generate electronic output signals based on the inputs, and send the output signals to the communication device. The communication device simply does not transmit these output signals (e.g., as part of the communication session, etc.) when the mute feature is activated.

Due to these characteristics, hackers and thieves may gain access to sounds and images captured by the communication device (or its accessories), even after the mute feature is activated. For example, a hacker may install malware on the communication device that modifies or otherwise compromises the device's hardware and/or software components. Such modifications may cause the device to surreptitiously record and/or transmit the output signals to a covert network server, regardless of whether the “mute” feature has been activated. The hackers or thieves may then access the covert server to eavesdrop on the users of the communication device, even when the “mute” feature is active.

To overcome the above-described limitations of existing solutions, the various embodiments include systems and methods of positively disconnecting signal paths between the communication device and its input or accessory devices. By positively disconnecting the signal paths, the various embodiments prevent inadvertent, unintentional, or surreptitious signal transmissions, and better protect the device from hackers, thieves, and cyberattacks.

In some embodiments, the communication device may be equipped with, or in communication with, a disconnect unit. The disconnect unit may be configured to electromechanically break a signal path, such as an audio path or a USB path, between an accessory device and the communication device.

In some embodiments, the disconnect unit may be configured to maintain communications with the communication device on behalf of the accessory so that signal paths between the accessory and the communication device may be opened (e.g., to disconnect the signal paths between the accessory and the communication device) and closed (e.g., to reestablish the signal path). Also, by maintaining communications, the disconnect unit may provide or relay input from the accessory to the communication device (e.g., to continue a communication session) without delay. For example, the disconnect unit may prevent or avoid delays often caused by, for example, the reinitialization of a driver for an input/accessory device. In some embodiments, the disconnect unit may open and/or close the signal path while maintaining a communication session that uses the signals received from the accessory.

In some embodiments, the disconnect unit may be configured to positively disconnect the signal paths in a default operating state.

In some embodiments, the disconnect unit may be configured to positively disconnect the signal paths when an accessory enters or is placed in an off-hook state, a non-operational state, or other similar state.

In some embodiments, the disconnect unit may be configured to positively disconnect the signal paths when a “mute” or “hold” function of the disconnect unit is activated. In some embodiments, the disconnect unit may be configured to activate its “mute” or “hold” function in response to determining that a “mute” feature of a software application controlling a communication session has been activated.

In some embodiments, the disconnect unit may include a user interface, such as switch, which may enable closing or restoring the electronic paths. The user interface element may allow the disconnect unit to enter and operate in a connected state and/or to enter a disconnected state. The disconnect unit may also include an indicator component, such as a visual indicator or another type of indicator, that identifies the operating state of the disconnect unit and/or of a state of the signal paths. For example, the disconnect unit (or its indicator component) may be configured to activate a red light to indicate that the signal paths are enabled, and activate a green light to indicate that the signal paths are disabled.

In some embodiments, the disconnect unit may include one or more metallic-contact disconnect switches or relays. The metallic-contact disconnect switches or relays may be configured to mechanically open (e.g., disconnect) a signal path.

In some embodiments, the disconnect unit may include controls for manual operation, such as to manually originate or answer a communication session, manually connect or disconnect the signal paths, etc.

In some embodiments, the disconnect unit may be configured to physically prevent signal transmissions from emanating or originating from the disconnect unit. For example, the disconnect unit may be configured to physically prevent audio signals from propagating of on any of the wires leaving the disconnect unit when the disconnect unit is active or in the default operating state.

In some embodiments, the disconnect unit may configured or arranged so that is unable to transmit a signal (such as an audio signal) when it is operating in the default operating state. In these embodiments, intrusive physical modifications within the disconnect unit would be required for signal transmission.

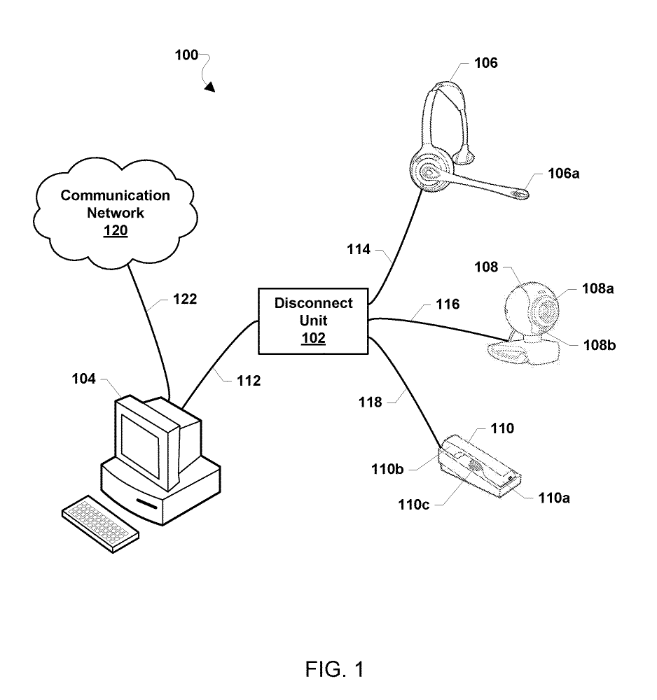

FIG. 1 illustrates a communication system 100 that includes a disconnect unit configured to connect and disconnect the signal paths in accordance with the various embodiments. In the example illustrated in FIG. 1, the system 100 includes a communication device 104 in the form of a personal computing device. The communication device 104 includes communication links to various accessories, such the illustrated headset 106, camera 108, and handset 110. A disconnect unit 102 is interposed between the communication device 104 and the accessories 106-110. The accessories 106-110 may communicate with the disconnect unit 102 via communication links 114, 116, and 118. The communication device 104 may communicate with the disconnect unit 102 over communication link 112.

In the illustrated example, the communication device 104 includes a communication link 122 to a communication network 120. The communication device 104 may also include a processor configured with processor-executable instructions to establish and use a communication session (e.g., a Skype videoconference, etc.) to other devices (not illustrated in FIG. 1) via the communication network 120. The communication session may include, for example, a Voice over Internet Protocol (VoIP) communication session or another similar communication session.

Each of the communication links 114, 116, and 118 may conduct a signal from an accessory. For example, the headset 106 may include a microphone 106a, which may generate a signal responsive to audio input that may be transmitted along the communication link 114. As another example, the camera 108 may include a video input 108a and a microphone 108b, each of which may generate a signal based on received input that may be transmitted along the communication link 116. As another example, the handset 110 may include a microphone 110a and a speaker 110b, both of which may generate a signal responsive to, for example, received audio input. Similarly, the handset 110 may include an optional cradle, which may include a microphone 110c (such as a “speakerphone” microphone) that may generate a signal responsive to received audio input. The signal generated by the handset 110 may be transmitted along the communication link 118.

A signal transmitted along the communication links 114, 116, and 118 may be received by the disconnect unit 102. In some embodiments, the disconnect unit may block transmission of a signal that is received from the accessory 106, 108, 110 from the disconnect unit 102 to the communication device 104. In some embodiments, the disconnect unit 102 may mechanically disconnect or break an electronic signal path between the accessory 106, 108, 110 and the communication device 104 to prevent the transmission of the signal that is generated by the accessory 106, 108, 110 to the communication device 104. In some embodiments, the disconnect unit 102 may include circuitry and/or a processor that may maintain communication between the disconnect unit 102 and the communication device 104 in order to maintain a software-level connection between the disconnect unit 102 and the communication device 104 on behalf of the accessory 106, 108, 110. In some embodiments, the circuitry and/or processor may include a CODEC (coder-decoder) unit that communicates with the communication device 104 in order to maintain the initialization of a device manager (such as, e.g., a device driver) for the accessory 106, 108, 110. In such embodiments, the disconnect unit 102 may mechanically reconnect an electronic signal path between the accessory 106, 108, 110 and the communication device 104, and the communication device 104 may receive input from the accessory 106, 108, 110 without a delay caused by re-initializing a device manager or device driver for the accessory 106, 108, 110. In some embodiments, when the disconnect unit 102 is initially connected with the communication device 104, the CODEC unit may initialize device drivers for one or more accessories. The CODEC unit may also load device drivers and/or CODEC software to the communication device 104. The CODEC unit may maintain a software-level communication or connection with the communication device 104 regardless of whether the signal path(s) between the accessory 106, 108, 110 and the communication device 104 are open or closed.

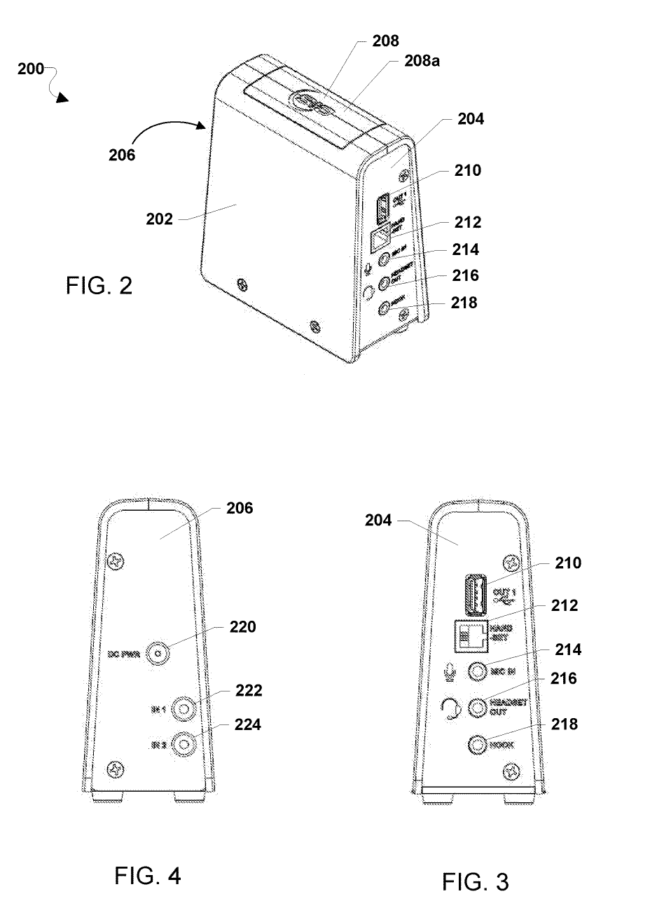

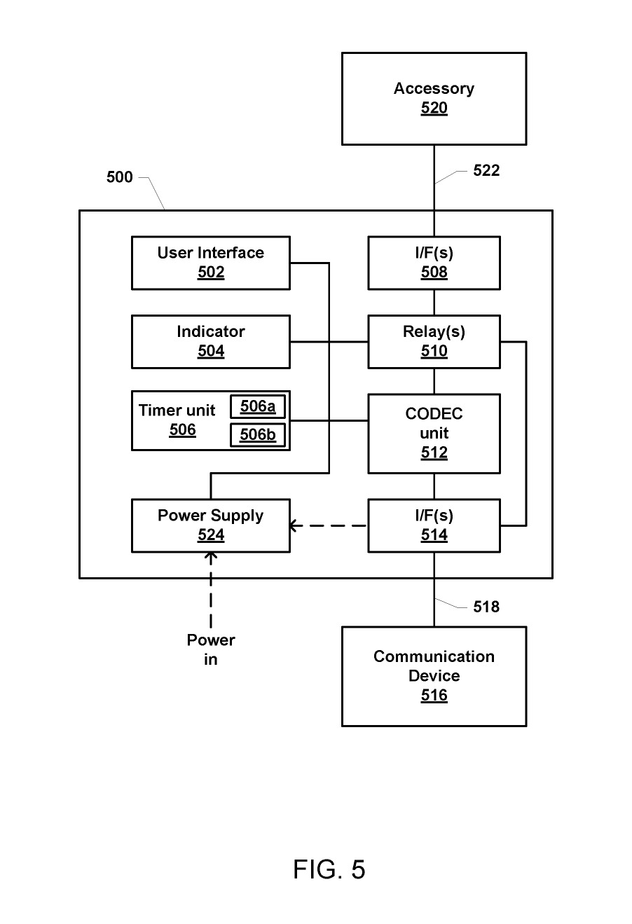

FIGS. 2-4 illustrate a disconnect unit 200 that is suitable for preventing inadvertent, unintentional or surreptitious signal transmissions in accordance with the various embodiments. In some embodiments, the disconnect unit 200 may be the same as or similar to the disconnect unit 102 illustrated in FIG. 1 and discussed above.

The disconnect unit 200 may include a body 202, which may include a molded housing or another similar enclosure of various components of the disconnect unit 200. The disconnect unit 200 may include a user interface 208, such as one or more switches, sliders, buttons, touch panels, or another device to receive an input. In some embodiments, the user interface 208 may be disposed on or supported by the body 202. In some embodiments, the user interface 208 may include an indicator 208a of an operating state of the disconnect unit 200. For example, the indicator 208a may include a light, such as a light emitting diode (LED), configured to emit one or more colors indicative of the operating state of the disconnect unit 200.

In various embodiments, the indicator 208a may include speaker to emit a sound, a haptic feedback device to vibrate, or another device to provide an indication of the operating state of the disconnect unit 200.

In some embodiments, the user interface 208 may include a transparent or translucent cover within which the indicator 208a may be disposed. In some embodiments, a portion of the body 202 supporting the user interface 208 may be shaped such that the indicator 208a is visible from a substantially 360-degree angle around the disconnect unit 200. For example, a top portion of the body 202 may be substantially curved such that the indicator 208a is visible from a substantially 360-degree angle around the disconnect unit 200.

The body 202 may include a first panel 204 and a second panel 206. Each of the first panel 204 and the second panel 206 may include one or more communication ports.

The first panel 204 may include a universal serial bus (USB) port 210, an RJ-type port 212, and one or more 3.5 mm ports 214, 216, 218. The USB port 210 may enable the disconnect unit 200 to communicate with a USB device, such as a camera, headset, or handset. The RJ-type port 212 may enable the disconnect unit 200 to communicate with, for example, a telephone device or handset. In some embodiments, the one or more 3.5 mm ports 214, 216, 218 may include a microphone input port, a microphone/handset output port, and a telephone communication port. In some embodiments, the telephone communication port may be in communication with a telephone cradle or other device that may provide a signal indicating that an accessory (e.g., the telephone handset 110a) has been placed in an on-hook position, a non-use state, or into an idle state. For example, an accessory may provide a signal to the communication port 218 that a telephone handset has been placed in a handset cradle of the accessory.

The second panel 206 may include a power input port 220 and one or more communication ports 222, 224. In some embodiments, the communication ports 222, 224 may enable communication with a communication device (e.g., the communication device 104) using an appropriate protocol, such as USB or another communication protocol.

The number, type, and disposition of various ports and connectors illustrated in FIGS. 2-4 is merely exemplary, and in various embodiments the disconnect unit 200 may include any number and/or type of ports and connectors in a variety dispositions.

FIG. 5 illustrates a system including a disconnect unit 500 according to various embodiments. With reference to FIGS. 1-5, the disconnect unit 500 may include a user interface 502, an indicator 504, a timer unit 506, one or more first interfaces 508, one or more relays 510, a CODEC unit 512, one or more second interfaces 514, and a power supply 524. The various elements of the disconnect unit 500 may communicate over a communication link such as circuitry or a communication bus.

The disconnect unit 500 may communicate with an accessory 520 through the first interface 508 over a communication link 522. In some embodiments, the accessory 520 may be similar to the headset 106, the camera 108, or the telephone 110. The first interface 508 may include one or more communication ports, which may be similar to the communication ports 210, 212, 214, 216, 218. The disconnect unit 500 may also communicate with the communication device 516 through the second interface 514 over a communication link 518. The communication device 516 may be similar to the communication device 104. The second interface 514 may include one or more communication ports, which may be similar to the communication ports 222, 224.

The first interface 508, the relay(s) 510, the CODEC unit 512, and the second interface 514 may form a signal path which may communicate signals between the accessory 520 and the communication device 516. For example, the accessory 520 may generate a signal and transmit the signal over the communication link 522. The first interface 508 may receive the signal and convey the signal to a relay 510. The relay 510 may convey the signal to the CODEC unit 512. The CODEC unit 512 may transmit the signal to the second interface 514. The second interface 514 may send the signal to the communication device 516 via the communication link 518. Similarly, the communication device 516 may generate a signal and transmit such signal to the accessory 520 in a reverse direction via the signal path.

In various embodiments, the disconnect unit 500 may include a default operating state in which signal path is open (i.e., disconnected) and a connected state in which the signal path is closed (i.e., connected). In some embodiments (which may be may be similar to the user interface 208) and may include one or more switches, sliders, buttons, touch panels, or another device to receive an input that may change the operating state of the disconnect unit 500. For example, the user interface 502 may receive an input, and in response to the input the user interface 502 may send a signal to open (i.e., disconnect) or close (i.e., connect) the signal path. For example, the user interface 502 may send a signal responsive to an input to the one or more relays 510. The relay(s) 510 may include one or more electromechanical devices that may physically open or close (i.e., physically disconnect or connect an electrical connection) in response to such signal. In some embodiments, the user interface 502 may be electrically and/or electronically isolated so that the user interface 502 may not be manipulated through any firmware or software.

In some embodiments, the relay(s) 510 may include one or more metallic-contact disconnect switches or relays that may mechanically open (e.g., disconnect) or close (e.g., connect) a signal path. In some embodiments, the relay(s) 510 may be physically isolated from any external wiring such that the relay(s) 510 cannot be controlled, overridden, or otherwise manipulated by software, firmware, telnet, or any other networked communication to the disconnect unit 500.

When the relay(s) 510 are open, the disconnect unit 500 may physically prevent a signal that is received from the accessory 520 from being transmitted from the disconnect unit 500, such as an audio signal, on any wires leaving the disconnect unit (e.g., from the interface(s) 514 to the communication link 518). In some embodiments, the relay(s) 510 may be open (e.g., the signal path may be disconnected) when the disconnect unit 500 is in the default operating state. In some embodiments, the disconnect unit 500 may be unable to transmit a signal to the communication device when operating in the default operating state except by intrusive physical modifications within the disconnect unit 500.

The indicator 504 (which may be similar to the indicator 208a) may include one or more lights, speakers, haptic feedback devices, or another device that may provide an indication of an operating state of the disconnect unit 500. The indicator 504 may provide a visual, audible, tactile, or other indication that the signal path is open or closed. For example, to indicate that the signal path is open (i.e., is disconnected), power may be supplied to a green LED, or an LED may be controlled to emit green light. As another example, to indicate that the signal path is closed (i.e., is connected), power may be supplied to a red LED, or an LED may be controlled to emit red light. In some embodiments, the indicator 504 may indicate all times when the physical isolation of signal path is not active (e.g., when the signal path is closed). In some embodiments, the indicator 504 may provide an indication in response to physical act (e.g., taking an instrument of accessory off-hook).

The CODEC unit 512 may include circuitry and/or processor that may communicate with the communication device 516 in order to maintain a software-level connection between disconnect unit 500 and the communication device 516 on behalf of the accessory 520. In some embodiments, the software-level connection may include the initialization of a device manager (such as, e.g., a device driver) for the accessory 520. In some embodiments, when the disconnect unit 500 and the communication device 516 are initially connected, the CODEC unit 512 and the communication device 516 may perform device driver negotiation for the accessory 520. The disconnect unit 102 may mechanically disconnect and reconnect the signal path between the accessory 520 and the communication device 516, and the communication device 104 may receive input from the accessory 520 without a delay caused by re-initializing a device driver for the accessory 520. In some embodiments, when the disconnect unit is in the default operating state, the CODEC unit is prevented from passing audio signals electrically outside the disconnect unit.

The timer unit 506 may include a countdown timer 506a that may count a time period during which the disconnect unit 500 may operate in the connected state. In some embodiments, upon receiving an input to change the operating state of the disconnect unit 500 from the default operating state (i.e., signal paths disconnected) to the connected operating state (i.e., signal path connected), in addition to sending a signal to the relay(s) 510 to close the signal path, the user interface 502 may also send a signal to the timer unit 506. In response to receiving the signal from the user interface 502, for example, the timer unit 506 may initialize the countdown timer 506a, which may count a duration of time (e.g., 15 minutes) during which the disconnect unit 500 may operate in the connected state. In some embodiments, in response to determining that the countdown timer 506a has expired, the timer unit 506 may send a signal to the relay(s) 510 to open the relay(s) 510, disconnecting the signal path, and changing the operating state of the disconnect unit 500 to the default operating state. In some embodiments, in response to determining that the countdown timer 506a has expired, the timer unit 506 may also send the signal to the indicator 504, which may provide an indication of the change in the operating state of the disconnect unit 500 (e.g., may provide an indication that the signal path is open).

Additionally or alternatively, in response to determining that the countdown timer 506a has expired, the timer unit 506 may initialize a warning timer 506b. The warning timer may count a brief warning period (e.g., 10 seconds) at the end of which the timer unit 506 may send a signal to the relay(s) 510 to open the relays, disconnecting the signal path. The timer unit 506 may also send a signal to the indicator(s) 504 to provide an indication that the warning timer is counting down. In some embodiments, the indicator 504 may provide a flashing light, sound indication, haptic indication, or some other indication that the warning timer is counting down. In some embodiments, in response to determining that the warning timer 506b has expired, the timer unit 506 may send a signal to the relay(s) 510 to open the relay(s) 510 and disconnect the signal path, changing the operating state of the disconnect unit 500 to the default operating state. In some embodiments, during the warning period, if an input is received at the user interface 502, the countdown timer and the warning timer may reset. In some embodiments, the countdown timer and the warning timer may reset without disconnecting an ongoing communication session (e.g., a call).

In some embodiments, disconnect unit 500 may receive a signal from an accessory via the interface 508 indicating that the accessory 520 has been placed in an on-hook position, a non-use state, or into an idle state. For example, an accessory may provide a signal that a telephone handset has been placed in a handset cradle of the accessory. In some embodiments, in response to receiving the signal that the accessory 520 has been placed in an on-hook position, the relay(s) 510 may open the signal path, and the disconnect unit 500 may operate in the default operating state. In some embodiments, the disconnect unit 500 may return to operating in the default operating state within one second of receiving the signal from the accessory 520.

In some embodiments, the relay(s) 510 and the second interface 514 may communicate a signal directly, without the involvement of the CODEC unit 512. For example, an accessory that employs a USB connection may not require, for example, the involvement of the CODEC unit 512 in order to maintain a software-level connection between disconnect unit 500 and the communication device 516 on behalf of the accessory 520.

The power supply 524 may receive power, for example, from an electrical source such as alternating current (AC) or direct current (DC), or from the second interface 514 (e.g., power over USB).

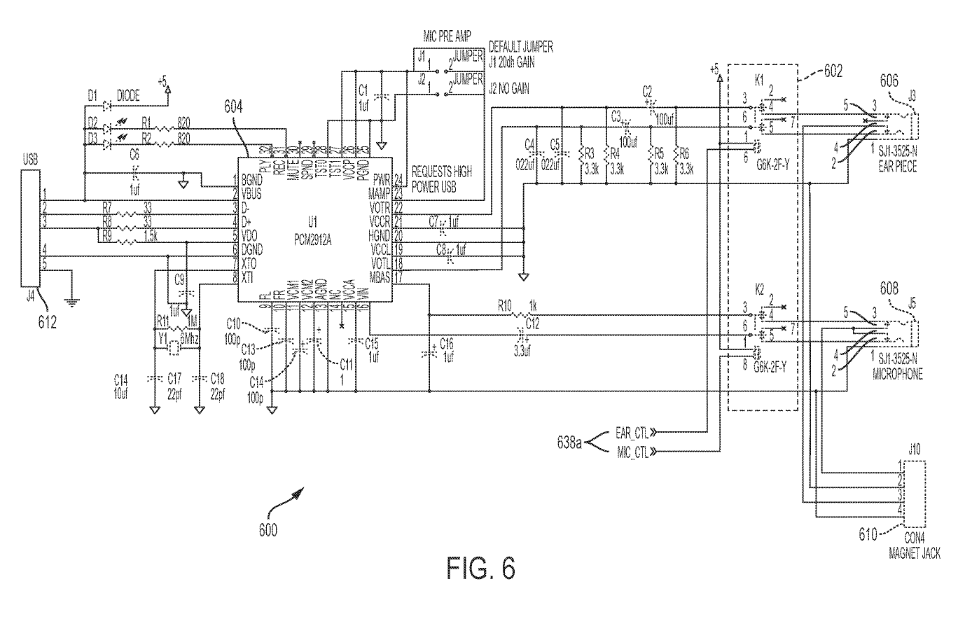

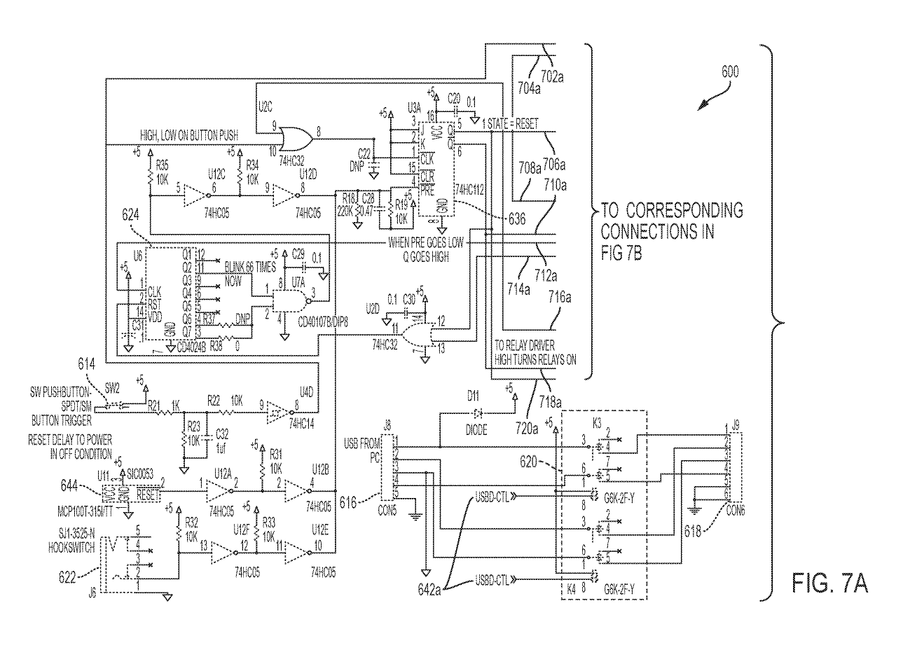

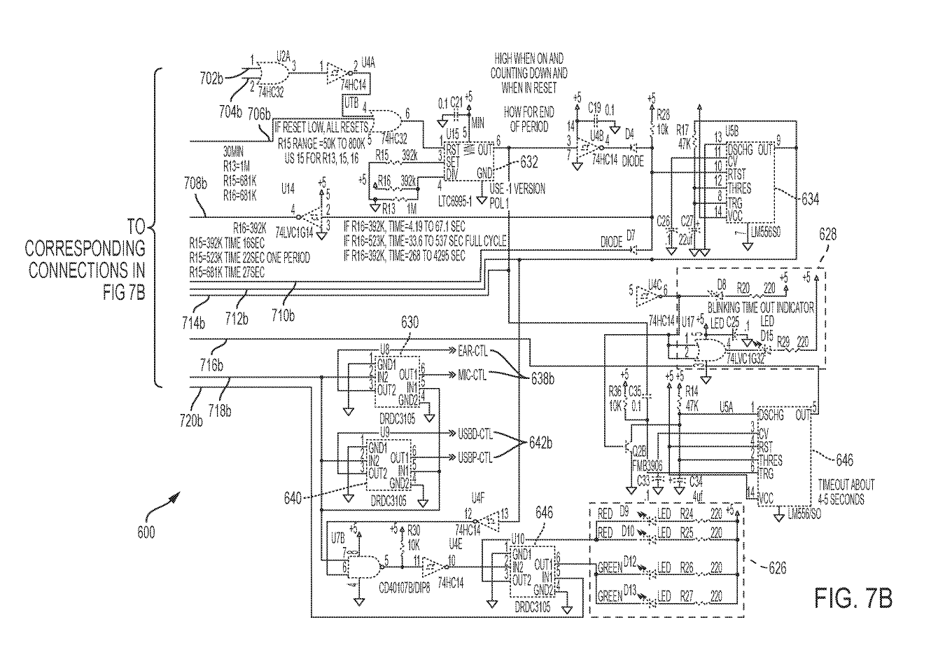

FIGS. 6, 7A, and 7B are circuit diagrams illustrating components of an embodiment disconnect unit 600. With reference to FIGS. 1-7B, the disconnect unit 600 may be similar to the disconnect unit 102, 200, and 500.

The disconnect unit 600 may include one or more accessory interfaces 606, 608, and 610. In some embodiments, the accessory interfaces 606, 608, 610 may be similar to the USB port 210, the RJ-type port 212, and/or the communication ports 212, 214, 216, and/or to the first interface(s) 508. The disconnect unit 600 may communicate with an accessory (not illustrated) via one or more of the accessory interfaces 606, 608, 610. In some embodiments, the accessory may be similar to the headset 106, the camera 108, the telephone 110, and/or the accessory 520. The disconnect unit 600 may also include a communication device interface 616. The disconnect unit 600 may communicate with a communication device (not illustrated) via the computing device interface 612. In some embodiments, the second interface 616 may be similar to the communication ports 222, 224 and/or the second interface(s) 616.

The disconnect unit 600 may also include a CODEC unit 604 and one or more relays 602. The CODEC unit 604 may be similar to the CODEC unit 512. The relays 602 (which may be similar to the relays 510) may include electromechanical elements to physically open or close electrical connections of the signal path. The accessory interfaces 606, 608, 610, the relays 602, the CODEC unit 604, and the computing device interface 612 may form one or more signal paths that may communicate signals between the accessories and the communication device.

The disconnect unit 600 may include a USB port 616, which may communicate with a USB port 618 via relays 620. The USB port 616 may be similar to the communication ports 222, 224, and may enable the disconnect unit 600 to communicate with the communication device. The USB port 618 may be similar to the communication port 210, and may enable the disconnect unit 600 to communicate with a USB type accessory that may communicate with the communication device without passing a signal through the CODEC unit 604. (An example of such a USB type accessory may include a USB camera.) The USB port 616, the relays 620, and the USB port 618 may form a signal path that may communicate signals between a USB type accessory and the communication device. In some embodiments, the signal path formed by the USB port 616, the relays 620, and the USB port 618 may enable the use of one or more USB accessories (e.g., a USB data drive, a USB hub to multiple accessories, etc.) as long as the signal path is closed. In some embodiments, the one or more USB accessories may be used during a time period during which the relays 620 are closed (e.g., a countdown period and/or a warning period), and at the expiration of the time period, the relays 620 may open, disconnected the signal path and rendering the one or more USB accessories in communication with the USB port 618 inaccessible. This feature may enable, for example, use of a USB accessory for the time period, after which the USB accessory is rendered inaccessible, and therefore secure, after the expiration of the time period.

The disconnect unit 600 may include a switch 614 (which may be similar to the user interface 208 and the user interface 502). Actuation of the switch 614 (e.g., through an input, such as a button press) may send a signal via a flip-flop switch 636 to relay drivers 630 and 640. The relay driver 630 may send control signals via control signal outputs 638b to control signal inputs 638a. The control signals received at the control signal inputs 638a may actuate the relays 602 to control the relays 602 to open or close their electrical connections. The relay driver 640 may send control signals via a control signal outputs 642b to control signal inputs 642a. The control signals received at the control signal inputs 642a may actuate the relays 620 to control the relays 620 to open or close their electrical connections. In various embodiments, the disconnect unit 600 may include a default operating state in which the relays 602 and 620 are open (i.e., disconnected). In response to an input received at the switch 614, the relay drivers 630, 640 may send signals instructing the relays 602, 620 to close, thereby connecting the respective electrical connections of the relays 602, 620.

In some embodiments, the disconnect unit 600 may include a hook switch 622, which may enable the disconnect unit 600 to receive an on-hook signal from an appropriate accessory, such as a handset or another similar accessory. The on-hook signal may indicate that the accessory has been placed in a non-use state or in an idle state. For example, the accessory may provide a signal to the hook switch 622 that a telephone handset has been placed in a handset cradle of the accessory. The hook switch 622 may send a signal via the flip-flop switch 636 to the relay drivers 630 and 640. The relay drivers 630 and 640 may then send control signals via their respective control signal outputs 638b and 642b to control the relays 602 and 620 to open their respective electrical connections.

The disconnect unit 600 may include one or more indicators, such as LEDs 626 and LEDs 628. The LEDs 626, 628 may be similar to the indicator 208a and the indicator 504. In some embodiments, the LEDs 626 may be instructed via an LED driver 646 to provide an indication of an operating state of the disconnect unit 600. For example, when a signal is sent to the relay drivers 630, 640 (for example, from the switch 614), a signal may also be sent to the LED driver 646, which may control the LEDs 626 to provide an indication corresponding to the operating state of the disconnect unit 600. For example, to indicate that the signal paths are open (i.e., are disconnected), power may be supplied to a green LED, or an LED may be controlled to emit green light. As another example, to indicate that the signal paths are closed (i.e., are connected), power may be supplied to a red LED, or an LED may be controlled to emit red light.

The disconnect unit 600 may include timers 632 and 634. The timers 632, 634 may be similar to the timers 506a and 506b in the timer unit 506. In some embodiments, when a signal is sent to the relay drivers 630, 640 (for example, from the switch 614), a signal may also be sent to the timer 632 (such as an initialization signal), and the timer 632 may count a time period during which the disconnect unit 600 may operate in the connected state. For example, the timer 632 may count a duration of time (e.g., 15 minutes) during which the disconnect unit 600 may operate in the connected state. In some embodiments, in response to determining that the timer 632 has expired, the timer 632 may send a signal to relay drivers 630 and 640 to open the relays 602 and 620, respectively, disconnecting the signal paths, and changing the operating state of the disconnect unit 600 to the default operating state. In some embodiments, in response to determining that the timer 632 has expired, the timer 632 may also send the signal to the LED driver 646, which may control the LEDs 626 to provide an indication of the change in the operating state of the disconnect unit 600.

Additionally or alternatively, in response to determining that the timer 632 has expired, the timer 632 may send a signal (such as an initialization signal) to the timer 634. The timer 634 may count a brief warning period (e.g., 10 seconds) at the end of which the timer 634 may send a signal to relay drivers 630, 640 to open the relays 602, 620, disconnecting the signal paths, and changing the operating state of the disconnect unit 600 to the default operating state. In some embodiments, the timer 634 may also send a signal to the LEDs 628 to provide an indication that the warning timer is counting down. In some embodiments, the LEDs 628 may provide a flashing light to indicate that the timer 634 is counting down. In some embodiments, in response to determining that the timer 634 has expired, the timer 634 may send a signal to relay drivers 630, 640 to open the relays 602, 620, disconnecting the signal paths. In some embodiments, the disconnect unit 600 may include a counter 624 may function with the timer 634 to determine whether the timer 634 has expired. In some embodiments, the counter 624 may count a number of flashes produced by the LEDs 628.

The disconnect unit 600 may include a timer 646, that may enable the timers 632 and 634 to be reset without changing a state of the relays 602, 620. In some embodiments, the timer 646 may be set to a relatively short time period, such as ½ second or ¼ second. The timer 646 may permit or induce a delay for the duration of its time period to enable the timers 632 and 634 to be reset without changing the state of the relays 602, 620.

In some embodiments, the disconnect unit 600 may include a power-on reset chip 644. The power on-reset chip 644 may enable the disconnect unit 600 to begin operation after powering up in the default operating state (i.e., with the signal paths disconnected). In some embodiments, upon powering up the disconnect unit 600, the power-on reset chip may send a signal via the flip-flop switch 636 to open the relays 602, 620.

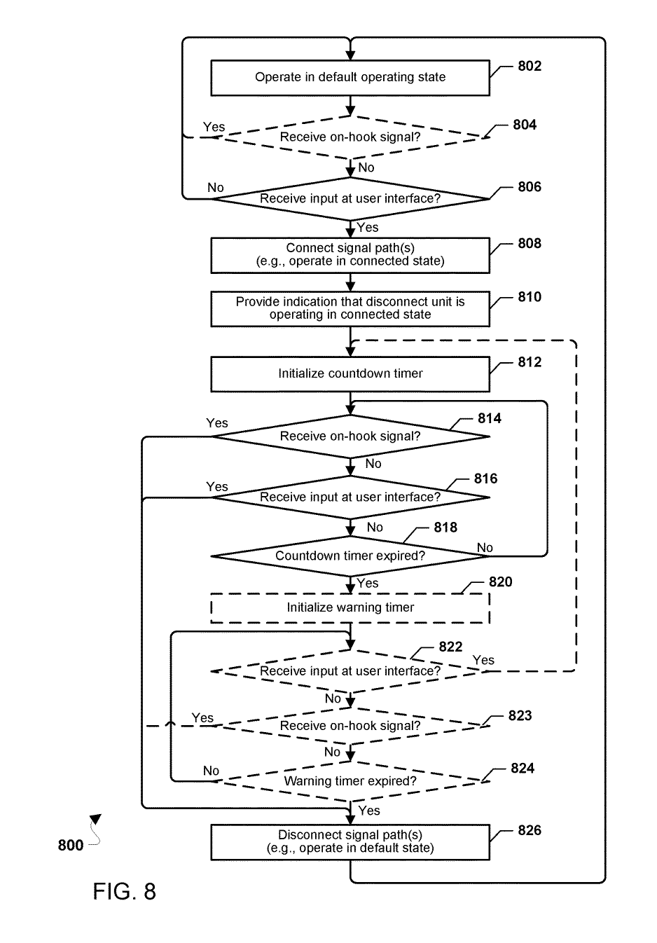

FIG. 8 is a process flow diagram illustrating a method 800 for mitigating an induced electrical signal from an appliance in a powered-off state. With reference to FIGS. 1-8, the method 800 may be implemented by a disconnect unit (e.g., the disconnect unit 102, 200, 500, 600).

In block 802, the disconnect unit may operate in a default operating state. In the default operating state, one or more signal paths between an accessory and a communication device may be opened by the disconnect unit to prevent a signal received from the accessory from being sent by the disconnect unit to the communication device.

In optional determination block 804, the disconnect unit may determine whether an on-hook signal has been received. For example, the disconnect unit may receive an on-hook signal from a hook switch (e.g., the hook switch 622). The on-hook signal may indicate that an accessory is in a non-use state or in an idle state.

In response to determining that the on-hook signal has been received (i.e., optional determination block 804=“Yes”), the disconnect unit may continue to operate in the default operating state in block 802.

In response to determining that the on-hook signal has not been received (i.e., optional determination block 804=“No”), in determination block 806, the disconnect unit may determine whether a user interface receives an input. In response to determining that the user interface does not receive input (i.e., determination block 806=“No”), the disconnect unit may continue to operate in the default operating state in block 802.

In response to determining that the user interface receives an input (i.e., determination block 806=“Yes”), the disconnect unit may connect the one or more signal paths in block 808. For example, the disconnect unit may operate in a connected state such that the accessory may communicate signals to the communication device.

In block 810, the disconnect unit may provide an indication that the disconnect unit is operating in the connected state. For example, the disconnect unit may include one or more indicators that may indicate that the disconnect unit is operating in the connected state.

In block 812, the disconnect unit may initialize a countdown timer. The countdown timer may count a time period during which the disconnect unit may operate in the connected state.

In determination block 814, the disconnect unit may determine whether an on-hook signal is received. For example, the disconnect unit may receive an on-hook signal from an appropriate accessory, such as a handset or another similar accessory, which may provide a signal indicating that the accessory has been placed in a non-use state or in an idle state.

In response to determining that the disconnect unit has received an on-hook signal (i.e., determination block 814=“Yes”), the disconnect unit may disconnect the one or more signal paths in block 826. For example, the disconnect unit may operate in the default state such that the disconnect unit may block or prevent signals received from the accessory from being transmitted from the disconnect unit to the communication device.

The disconnect unit may then continue to operate in the default operating state in block 802.

In response to determining that the disconnect unit has not received an on-hook signal (i.e., determination block 814=“No”), the disconnect unit may determine whether the disconnect unit has received an input at the user interface in determination block 816.

In response to determining that the disconnect unit has received an input at the user interface (i.e., determination block 816=“Yes”), the disconnect unit may disconnect the one or more signal paths in block 826. For example, the disconnect unit may operate in the default state such that the disconnect unit may block or prevent signals received from the accessory from being transmitted from the disconnect unit to the communication device.

In response to determining that the disconnect unit has not received an input at the user interface (i.e., determination block 816=“No”), the disconnect unit may determine whether the countdown timer has expired in determination block 818.

In response to determining that the countdown timer has not expired (i.e., determination block 818=“No”), the disconnect unit may again determine whether the disconnect unit has received an on-hook signal in determination block 814.

In some embodiments, in response to determining that the countdown timer has expired (i.e., determination block 818=“Yes”), the disconnect unit may disconnect the one or more signal paths in block 826. For example, the disconnect unit may operate in the default state such that the disconnect unit may block or prevent signals received from the accessory from being transmitted from the disconnect unit to the communication device. The disconnect unit may then continue to operate in the default operating state in block 802.

In some embodiments, in response to determining that the countdown timer has expired (i.e., determination block 818=“Yes”), in optional block 820 the disconnect unit may initialize a warning timer. The warning timer may count a brief warning period (e.g., 10 seconds) at the end of which the disconnect unit may disconnect the one or more signal paths.

In optional determination block 822, the disconnect unit may determine whether the disconnect unit has received an input at the user interface. In response to determining that the disconnect unit has received an input at the user interface (i.e., optional determination block 822=“Yes”), the disconnect unit may reinitialize the countdown timer in block 812. In addition, the disconnect unit may stop the warning timer.

In response to determining that the disconnect unit has not received an input at the user interface (i.e., optional determination block 822=“No”), the disconnect unit may determine whether an on-hook signal has been received in optional determination block 823. For example, the disconnect unit may determine whether it has received an on-hook signal from a hook switch (e.g., the hook switch 622).

In response to determining that the on-hook signal has been received (i.e., optional determination block 823=“Yes”), the disconnect unit may disconnect the one or more signal paths in block 826.

In response to determining that the on-hook signal has not been received (i.e., optional determination block 823=“No”), the disconnect unit may determine whether the warning timer has expired in optional determination block 824. In response to determining that the warning timer has not expired (i.e., optional determination block 824=“No”), the disconnect unit may again determine whether the disconnect unit has received an input at the user interface in optional determination block 822.

In response to determining that the warning timer has expired (i.e., optional determination block 824=“Yes”), the disconnect unit may disconnect the one or more signal paths in block 826. For example, the disconnect unit may operate in the default state such that the disconnect unit may block or prevent signals received from the accessory from being transmitted from the disconnect unit to the communication device.

The disconnect unit may then continue to operate in the default operating state in block 802.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the disconnect unit 102, 200, 500, 600, and of the method 800 may be substituted for or combined with one or more operations of the disconnect unit 102, 200, 500, 600, and of the method 800 and vice versa.

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to other embodiments without departing from the spirit or scope of the embodiments. Thus, various embodiments are not intended to be limited to the embodiments shown herein but are to be accorded the widest scope consistent with the following claims and the principles and novel features disclosed herein.

What is claimed is:

1. A disconnect unit, comprising:
a first interface, configured to communicate with an accessory;
a second interface, configured to communicate with a communication device;
a relay, configured to physically connect a communication path between the first interface and the second interface; and
a codec unit, configured to maintain a software-level connection with the communication device via the second interface on behalf of the accessory.

2. The disconnect unit of claim 1, wherein the relay is configured to physically disconnect the communication path in a default operating state.

3. The disconnect unit of claim 1, wherein the relay is configured to physically connect the communication path in a connected operating state.

4. The disconnect unit of claim 1, wherein the relay comprises an electromechanical device configured to physically connect the communication path between the first interface and the second interface.

5. The disconnect unit of claim 1, further comprising:
a user interface, configured to receive an input;
wherein the relay is configured to physically connect the communication path in response to the input received at the user interface.

6. The disconnect unit of claim 1, wherein the codec unit is configured to maintain the software-level connection with the communication device when the communication path is physically disconnected.

7. The disconnect unit of claim 1, further comprising:
a timer unit, configured to count a first time period during which the disconnect unit may operate with the communication path physically connected.

8. The disconnect unit of claim 7, wherein the timer unit is configured to send a signal to the relay to physically disconnect the communication path in response to determining that the first time period has expired.

9. The disconnect unit of claim 7, wherein the timer unit is configured to count a second time period after the first time period has expired, and
wherein the timer unit is configured to send a signal to the relay to physically disconnect the communication path in response to determining that the second time period has expired.

10. An electrical circuit, comprising:
a first interface, configured to communicate with an accessory;
a second interface, configured to communicate with a communication device;
a relay, configured to physically connect a communication path between the first interface and the second interface; and
a codec unit, configured to maintain a software-level connection with the communication device via the second interface on behalf of the accessory.

11. The electrical circuit of claim 10, wherein the codec unit is electrically coupled to the second interface.

12. The electrical circuit of claim 10, wherein the relay is electrically coupled to the first interface.

13. The electrical circuit of claim 10, wherein when the communication path is physically connected by the relay, the relay is electrically coupled to the codec unit.

14. The electrical circuit of claim 10, wherein the codec unit is configured to maintain the software-level connection with the communication device via the second interface on behalf of the accessory when the relay physically disconnects the communication path.

15. A method of positively disconnecting a communication path between a first interface in communication with a communication device and a second interface in communication with an accessory to prevent inadvertent signal transmissions, comprising:
physically disconnecting the communication path between the first interface and the second interface in a default operating state by a relay disposed along the signal path;
maintaining a software-level connection with the communication device via the second interface on behalf of the accessory; and
physically connecting the communication path in a connected operating state to enable signal communication between the accessory and the communication device.

16. The method of claim 15, wherein the relay comprises an electromechanical device configured to physically connect the communication path between the first interface and the second interface.

17. The method of claim 15, wherein the relay is configured to physically connect the communication path in response to an input received at a user interface.

18. The method of claim 15, wherein maintaining a software-level connection comprises maintaining the software-level connection with the communication device via the second interface by a codec unit in communication with the first interface.

19. The method of claim 15, further comprising:
counting, by a timer unit, a first time period during which the disconnect unit may operate with the communication path physically connected.

20. The method of claim 19, further comprising:
sending, from the timer unit, a signal to the relay to physically disconnect the communication path in response to determining that the first time period has expired.
